(19) United States
(12) Patent Application Publication
(10) Pub. No.: US 2025/0240111 A1
(43) Pub. Date: Jul. 24, 2025

(54) SYSTEMS AND METHODS FOR WIDE AREA PRECISION TIME SYNCHRONIZATION

(71) Applicant: Verizon Patent and Licensing Inc., Basking Ridge, NJ (US)

(72) Inventors: Andrew Zarick, Los Angeles, CA (US); Orlando Martinez, Orient, NY (US); Scott Connolly, Lake Arrowhead, CA (US); Sudhakar Reddy Patil, Flower Mound, TX (US); Vijayakrishna P. Guduru, Denville, NJ (US); Christopher P. Wimmer, Cheverly, MD (US)

(73) Assignee: Verizon Patent and Licensing Inc., Basking Ridge, NJ (US)

(21) Appl. No.: 18/418,775

(22) Filed: Jan. 22, 2024

(51) Int. Cl. H04J 3/06; H04W 56/00

(52) U.S. Cl. CPC H04J 3/0667; H04W 56/001

(57) ABSTRACT

A system described herein may maintain and distribute precision time across diverse locations and network types, including wired and wireless networks. A particular device may receive topology information indicating a particular set of time synchronization nodes, out of a plurality of time synchronization nodes of a time synchronize network; communicate with the particular set of time synchronization nodes on an ongoing basis, wherein the device and the plurality of devices maintain precision time information based on the ongoing communication; receive a request for precision time information from a particular time synchronization client, wherein the particular time synchronization client is assigned to the device based on attributes of the time synchronization client and the device; and output, to the particular time synchronization client and in response to the request, the requested precision time information.

### BACKGROUND

Time synchronization across different devices may be used in various scenarios or applications, such as wireless network operation, audiovisual filming and editing, coordination between drones, or the like. Precision time, such as time that is precise to the order of nanoseconds, may ensure the quality and efficacy of such applications.

### BRIEF DESCRIPTION OF THE DRAWINGS

FIG. 1 illustrates an example overview of one or more embodiments described herein;

FIG. 2 illustrates an example of establishing a time synchronization network and assigning appropriate time synchronization nodes to time synchronization clients, in accordance with some embodiments;

FIG. 3 illustrates an example of delivering precision time information across diverse networks and geographical areas, in accordance with some embodiments;

FIG. 4 illustrates an example process for maintaining and delivering precision time information across diverse networks and geographical areas, in accordance with some embodiments;

FIGS. 5 and 6 illustrate example environments in which one or more embodiments, described herein, may be implemented;

FIG. 7 illustrates an example arrangement of a radio access network (“RAN”), in accordance with some embodiments; and

FIG. 8 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Precision time, such as time that is precise to the order of nanoseconds, may ensure the quality and efficacy of applications or services in which multiple devices operate based on time-based triggers or other types of coordination between devices that is based on time. For example, in a wireless network setting, maintaining the same precision time (e.g., to the order of nanoseconds) across various devices of the wireless network may allow for efficient allocation of resources (e.g., uplink and/or downlink radio resources) for User Equipment (“UEs”) accessing the wireless network. As another example, in an audiovisual filming and/or editing setting, maintaining the same precision time across devices such as cameras, soundboards, editing platforms, etc. may facilitate the creation and/or editing of content in order to achieve precisely timed camera angles, segment durations, queuing of on-camera events, etc. As another example, drones, unmanned aerial vehicles (“UAVs”), semi-autonomous cars, or the like may communicate with each other to coordinate movements (e.g., to avoid collisions), and maintaining precision time information may aid in such coordination.

Precision timekeeping techniques may employ Precision Time Protocol (“PTP”) messaging or other suitable techniques to maintain precision time information in local networks (e.g., wired networks) that are centralized and co-located (e.g., within the same building, the same facility, etc.). Such techniques may use wired connections to ensure low latency and jitter, thus facilitating the use of precision timekeeping techniques. Excessive latency or jitter may hinder the delivery of precision timekeeping communications (e.g., PTP messages or other suitable messages), thus preventing certain transmission methodologies (e.g., wireless techniques with high congestion, high jitter, etc.) from being feasible for delivering precision time services. Further, delivering precision time services from a server (e.g., which provides “authoritative” precision time information, such as Global Positioning System (“GPS”)-based time information, time information received from an atomic clock or other type of master clock, or other suitable authoritative time information) to a client device (e.g., which receives and uses the precision time information) that is located relatively far away may pose challenges such as excessive latency or jitter caused by network topology (e.g., excessive “hops”) or other factors. As such, traditional precision timekeeping mechanisms are unable to provide precision time information across relatively large distances (e.g., different states or provinces), and further lack the functionality to provide precision time information over wireless networks.

Embodiments described herein provide for precision time information to be maintained and distributed across relatively wide areas (e.g., an entire state, an entire country, etc.). Further, embodiments described herein provide for such precision time information to be delivered via wireless networks (e.g., Fifth Generation (“5G”) networks or other wireless networks featuring low latency and jitter). As such, precision time information may be provided as a service of a wireless network to UEs (e.g., mobile telephones, time synchronization receiver devices, drones, audiovisual equipment with wireless capability, etc.) that are located in relatively wide areas.

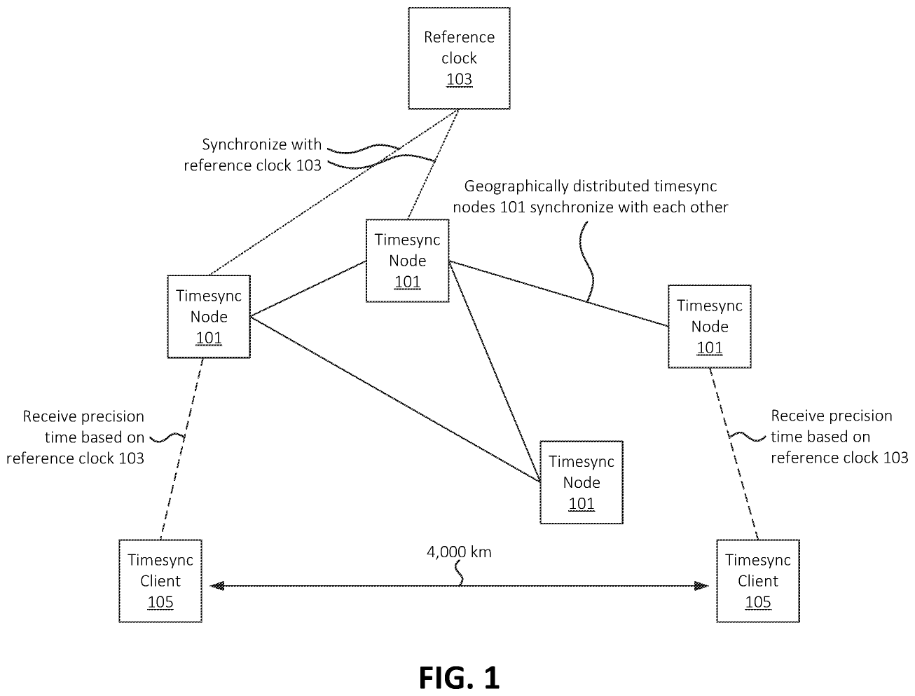

As shown in FIG. 1, for example, a set of time synchronization nodes 101 (where the figures abbreviate “time synchronization” as “timesync” for the sake of visual clarity) may be dispersed throughout a relatively wide area, such as a geographical region spanning thousands of kilometers. Although four time synchronization nodes 101 are shown in the figure, in practice, additional time synchronization nodes 101 may be deployed, in order to optimally deliver the time synchronization service of some embodiments. As shown, a routing topology of time synchronization nodes 101 may be configured, such that certain time synchronization nodes 101 communicate with each other to maintain time synchronization information (e.g., PTP messaging or other suitable messages). The messages may include bidirectional communications used to verify and correct precision time maintained by each time synchronization node 101, such that each time synchronization node 101 maintains the same precise time information (e.g., accurate and precise to the order of nanoseconds). The bidirectional messages may include, for example, time information as well as suitable error correction information or metadata, such as time of transmission, round trip delay time, etc., used by time synchronization nodes 101 to maintain the same precision time information.

As discussed below, the particular topology used by time synchronization nodes 101 may be determined in order to optimize the performance of the messaging between such time synchronization nodes 101. For example, particular time synchronization nodes 101 may be selected to communicate with each other, while other time synchronization nodes 101 may not be selected to communicate with each other. Time synchronization nodes 101 selected to communicate with each other may be selected based on factors such as number of “hops” (e.g., quantity of routers, switches, communication links, or other suitable features that may be referred to as discrete routing points), physical straight-line distance, distance or length of fibers or other communication links between respective time synchronization nodes 101, performance metrics such as latency or jitter, and/or other suitable factors. Time synchronization nodes 101 may, for example, be implemented by hardware resources located at geographically diverse facilities, server farms, cloud computing systems, or the like.

As additionally shown, one or more time synchronization nodes 101 may synchronize with one or more reference clocks 103. For example, in addition to communicate with other time synchronization nodes 101, a given time synchronization node 101 may communicate with reference clock 103 to receive “master,” “authoritative,” “reference,” etc. time information. In some embodiments, the “communication” with reference clock 103 may include receiving broadcast signals or other signals output by reference clock 103, without reference clock 103 necessarily receiving any communications from time synchronization node 101. For example, in some embodiments, reference clock 103 may include, may implement, may be implemented by, etc. a GPS-based timekeeping system, in which reference times are broadcasted to respective devices with the capability to receive or detect GPS signals. As another example, reference clock 103 may include or may be communicatively coupled to an atomic clock or other type of device or system that determines and provides reference time information. Generally, time synchronization nodes 101 may communicate with each other such that each time synchronization node 101 mains the same precision time as provided or determined by reference clock 103.

Since the routing topology of time synchronization nodes 101 is selected and configured in order to optimize the delivery of precision time information between time synchronization nodes 101 (e.g., minimal hops, distance, latency, jitter, etc.), the entire geographical area spanned by time synchronization nodes 101 may have access to the same precision time as kept by reference clock 103. For example, two different time synchronization clients 105 may be located relatively far apart (e.g., 4,000 kilometers from each other), but may receive the same precision time information. In this manner, the different time synchronization clients 105 may be able to coordinate time-based services with each other, such as movements or other operations performed in real-time. Further, even if time synchronization clients 105 are not inter-related in any way (e.g., are owned and/or operated by separate entities), time synchronization clients 105 may be able to operate in accordance with reliably delivered precision time information, such as via one or more wireless networks.

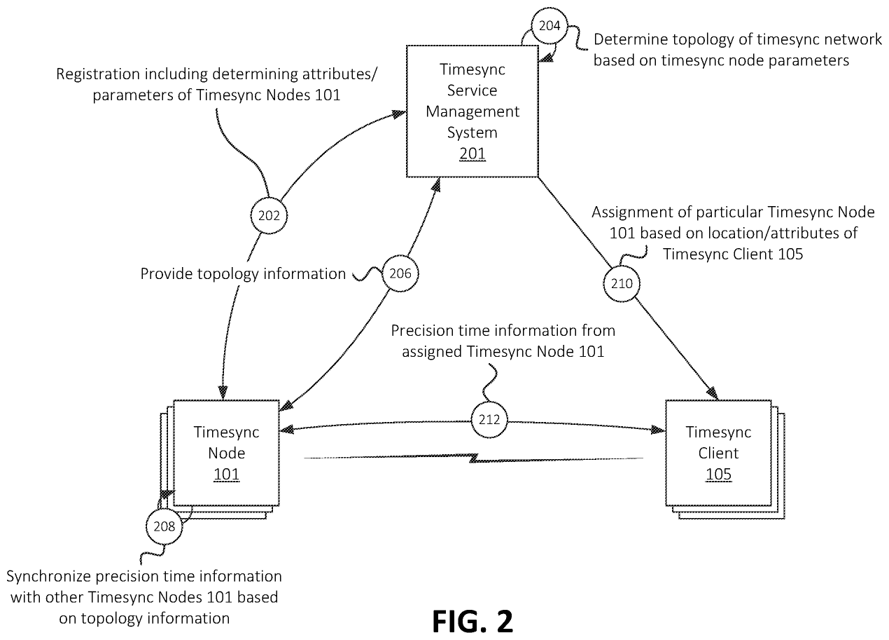

FIG. 2 illustrates an example configuration of time synchronization nodes 101 and time synchronization clients 105, in order to maintain precision time information among geographically diverse time synchronization nodes 101 as well to deliver such precision time information to geographically diverse time synchronization clients 105. As shown, Timesync Service Management System (“TSMS”) 201 may serve as a central control and/or configuration system for time synchronization nodes 101 and time synchronization clients 105. In some embodiments, multiple instances of TSMS 201 may be used, and/or the operations described herein with respect to TSMS 201 may be performed by one or more other devices or systems. In some embodiments, some or all of the operations described with respect to TSMS 201 (e.g., management and/or topology configuration of time synchronization nodes 101) may be performed by time synchronization nodes 101 in a distributed, cooperative, or federated manner.

As shown, time synchronization nodes 101 may register (at 202) with TSMS 201. For example, TSMS 201 may provide a web portal, an application, an application programming interface (“API”), or other suitable communication pathway via which time synchronization nodes 101 may register with and/or otherwise communicate with TSMS 201. For example, time synchronization nodes 101 may execute an application, implement an API, etc. via which time synchronization nodes 101 communicate with TSMS 201 via one or more networks (e.g., the Internet or other suitable networks). Registering a particular time synchronization node 101 may include indicating, to TSMS 201, attributes and/or parameters of the particular time synchronization node 101, such as identifiers or communication information (e.g., Internet Protocol (“IP”) addresses, device identifiers, etc.) associated with each respective time synchronization node 101. In some embodiments, the attributes and/or parameters may include location information (e.g., latitude and longitude coordinates, GPS coordinates, etc.) indicating where time synchronization node 101 is located. In some embodiments, the attributes and/or parameters of time synchronization node 101 may include an indication of whether time synchronization node 101 communicates with reference clock 103 or otherwise receives reference clock information. For example, some time synchronization nodes 101 may receive reference clock information from reference clock 103, while other reference clocks 103 may not receive such reference clock information.

In some embodiments, the attributes and/or parameters may include performance metrics, such as latency and jitter between particular time synchronization nodes 101. For example, a first time synchronization node 101 may determine performance metrics for communications between the first time synchronization node 101 and a second time synchronization node 101. Such performance metrics may include, for example, latency of communications from the first time synchronization node 101 to the second time synchronization node 101, latency of communications from the second time synchronization node 101 to the first time synchronization node 101, jitter of communications from the first time synchronization node 101 to the second time synchronization node 101, jitter of communications from the second time synchronization node 101 to the first time synchronization node 101, etc. In some embodiments, TSMS 201 may receive such registration information from some other device or system, such as a provisioning system or a management system associated with an owner or operator of time synchronization nodes 101. In some embodiments, the attributes and/or parameters may include other information based on which TSMS 201 may evaluate time synchronization nodes 101 and respective routes between time synchronization nodes 101, in order to determine an optimal network topology between time synchronization nodes 101 (e.g., to ensure optimal delivery of precision time information within one or more performance thresholds, such as latency thresholds, jitter thresholds, etc.).

As noted above, TSMS 201 may determine (at 204) a topology of a time synchronization network that includes time synchronization nodes 101. The “time synchronization network” may refer to a set of time synchronization nodes 101 that communicate with each other in order to maintain the same precision time, which may include synchronizing such time with a reference time determined or provided by reference clock 103, as discussed above. As noted above, TSMS 201 may determine (at 204) the topology of the time synchronization network based on optimizing or maximizing factors such as ensuring that latency and/or jitter thresholds are met for communications between respective time synchronization nodes 101. In some embodiments, the latency and/or jitter thresholds may be specified by PTP protocol specifications, automatically determined or adjusted using artificial intelligence/machine learning (“AI/ML”) modeling techniques or other suitable modeling techniques, or determined in some other suitable manner.

Further, the topology of the time synchronization network may be determined based on actual or expected location-based demand. The topology of the time synchronize network may refer to sets of time synchronize nodes that communicate with each other to maintain precision time. For example, TSMS 201 may determine (e.g., using AI/ML modeling techniques or other suitable modeling techniques), or may receive information indicating locations at which the precision time is requested or is likely to be requested, and may configure the topology to ensure that a precision time service is available at such locations. For example, TSMS 201 may identify a particular time synchronization node 101 that serves (e.g., is located in or proximate to) a location that is in demand for the precision time service, and may configure the topology of time synchronization nodes 101 such that the particular time synchronization node 101, serving such location, receives or synchronizes precision time with one or more other time synchronization nodes 101.

In some embodiments, time synchronization nodes 101 may provide attributes, metrics, etc. to time synchronization node 101 on a periodic or ongoing basis, such that TSMS 201 is able to maintain up-to-date information and dynamically adjust the topology “on the fly.” For example, in scenarios where a particular time synchronization node 101 becomes unavailable, congested, or otherwise not operating such that the particular time synchronization node 101 is able to synchronize precision time with other time synchronization nodes 101, TSMS 201 may modify the topology to remedy the issues with the particular time synchronization node 101 (e.g., remove time synchronization node 101 from the topology, modify routing to account for the issues with time synchronization node 101, etc.).

TSMS 201 may provide (at 206) some or all of the determined topology information to time synchronization nodes 101. For example, TSMS 201 may include information indicating particular routes or groups of time synchronization nodes 101, such groups of time synchronization nodes 101 that are assigned to communicate with each other to synchronize time information. The information may include IP addresses or other suitable identifiers of respective time synchronization nodes 101. In this manner, time synchronization nodes 101 may maintain information indicating other respective time synchronization nodes 101 with which to synchronize time information, and may proceed to synchronize (at 208) the precision time information with each other (e.g., using PTP messaging, bidirectional messaging, and/or other suitable techniques). Since the topology has been selected in accordance with thresholds associated with time synchronization, the synchronization (at 208) of precision time between time synchronization nodes 101 may ensure that all such time synchronization nodes 101 maintain the same precision time.

At some point, one or more time synchronization clients 105 may register with TSMS 201 and/or may request (at 210) a time synchronization service. For example, TSMS 201 may include or may be associated with a “front end,” a web portal, an API, etc. via which different time synchronization clients 105 may request the time synchronization service provided by the time synchronization network (e.g., by time synchronization nodes 101, under the management of TSMS 201). As discussed above, time synchronization client 105 may be, may include, may be implemented by, may be communicatively coupled to, and/or may otherwise be associated with a UE or other type of device that is capable of communicating over a network, such as a wireless network.

A given time synchronization client 105 may provide, for example, location information and/or other suitable attributes based on which TSMS 201 may assign a particular time synchronization node 101 with which time synchronization client 105 should communicate. Time synchronization client 105 may, for example, determine and report its own location (e.g., using GPS location determination techniques or other suitable techniques) to TSMS 201. As another example, time synchronization client 105 may output a request to a wireless network, to which time synchronization client 105 is connected, to provide the location of time synchronization client 105 to TSMS 201. TSMS 201 may have, for example, previously registered with time synchronization client 105 and/or the wireless network as an authorized recipient of location information of time synchronization client 105. Time synchronization client 105 may receive a callback Uniform Resource Identifier (“URI”) from TSMS 201 or some other suitable mechanism, which time synchronization client 105 may provide to the wireless network in order to request that the wireless network provide the location of time synchronization client 105 to TSMS 201. In some embodiments, TSMS 201 may receive or determine the location of respective time synchronization clients 105 through some other suitable mechanism.

TSMS 201 may assign (at 210) a particular time synchronization node 101 to time synchronization client 105, such that time synchronization client 105 communicates (at 212) with the assigned time synchronization node 101 to receive precision time information from the assigned time synchronization node 101. TSMS 201 may, for example, assign (at 210) the particular time synchronization node 101 to time synchronization client 105 based on comparing the location of time synchronization client 105 to locations of time synchronization nodes 101 (e.g., may select the closest time synchronization node 101 to time synchronization client 105 and/or may otherwise select the particular time synchronization node 101 based on the location of time synchronization client 105). TSMS 201 may, for example, output an indication to time synchronization client 105 of the IP address or other suitable identifier of the assigned time synchronization node 101, which time synchronization client 105 may use to communicate with time synchronization node 101. In some embodiments, TSMS 201 may output an indication to the assigned time synchronization node 101 of the IP address or other suitable of time synchronization client 105, such that the assigned time synchronization node 101 is notified that time synchronization client 105 is authorized to receive precision time information from time synchronization node 101, and/or that time synchronization node 101 should “push” or otherwise provide the precision time information to time synchronization client 105.

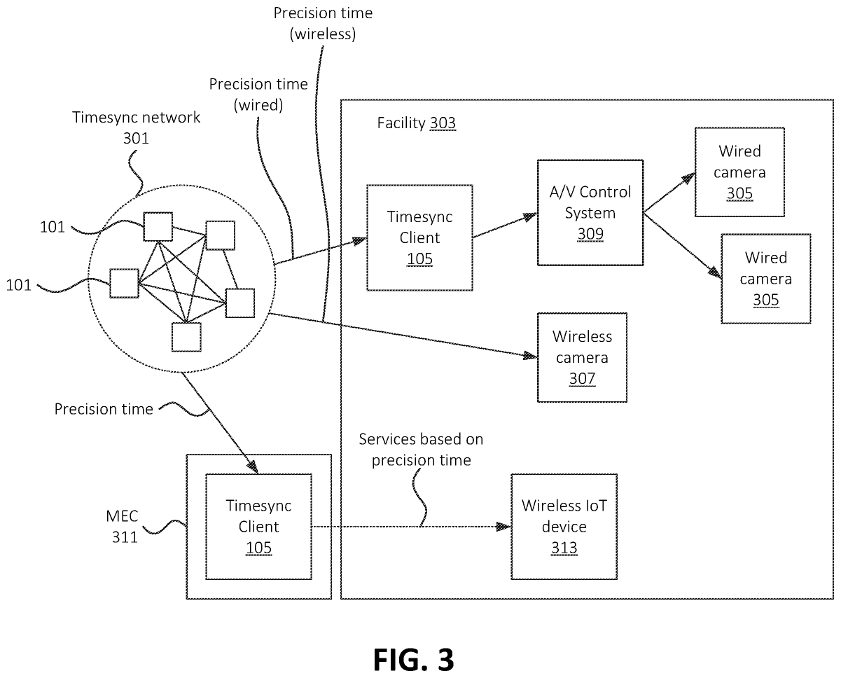

As shown in FIG. 3, different transmission mechanisms may be used to deliver precision time information, including wireless networks and/or wired networks, across wide geographical areas. For example, as shown, time synchronization network 301 may deliver precision time various devices or systems located in one or more facilities 303, to a Multi-Access/Mobile Edge Computing (“MEC”) device (referred to sometimes simply as a “MEC”), and/or other suitable devices or systems. In this example, facility 303 may include a particular time synchronization client 105, which may be connected to a network (e.g., the Internet) via a wired connection. For example, facility 303 may include a modem, a gateway, a router, etc. to which time synchronization client 105 is connected. As discussed above, time synchronization client 105 may have registered with TSMS 201 and/or may have otherwise received an assignment of a particular time synchronization node 101, of time synchronization network 301, from which time synchronization client 105 receives precision time services. In some embodiments, time synchronization client 105 may include, may be implemented by, and/or may be communicatively coupled to a dedicated device that is configured to communicate with time synchronization network 301 (e.g., with a particular time synchronization node 101 of time synchronization network 301) in order to receive precision time information. In some embodiments, time synchronization client 105 may forward, distribute, etc. precision time information to other devices located at facility 303.

In this example, assume that facility 303 is an audiovisual (“A/V”) facility, which may be or may include as a movie studio set, an editing room, or the like, in which various cameras configured to implement different operations (e.g., set camera focus, set camera position, set camera viewing angle, etc.) at certain coordinated times. Such cameras may include one or more wired cameras 305 and/or one or more wireless cameras 307. Further, in this example, assume that wired cameras 305 do not necessarily include or implement mechanisms by which wired cameras 305 maintain precision time. For example, wired cameras 305 may be controlled, configured, etc. by audiovisual (“A/V”) control system 309, which may instruct wired cameras 305 to perform certain operations (e.g., camera position operations, camera focus operations, etc.) at certain times. A/V control system 309 may be, for example, communicatively coupled to time synchronization client 105 (e.g., via a wired connection or other suitable connection that provides at least a threshold level of latency and jitter, or other metrics that ensure precision time services between time synchronization client 105 and A/V control system 309).

Wireless camera 307 may also be located at facility 303, and may not necessarily be wired to time synchronization client 105 and/or to A/V control system 309. Wireless camera 307 may be configured to perform certain operations at certain times (e.g., camera position operations, focus operations, etc.). Wireless camera 307 may receive precision time information from time synchronization network 301 (e.g., a particular time synchronization node 101) via a wireless network, such as a 5G network, using wireless circuitry included in or otherwise communicatively coupled to wireless camera 307. For example, wireless camera 307 may include one or more radios, antennas, etc. via which wireless camera 307 communicates wirelessly with a given time synchronization node 101 (e.g., via a base station of a radio access network (“RAN”) to which wireless camera 307 is connected). In some embodiments, wireless camera 307 may be configured to maintain or request a wireless connection according to a particular radio access technology (“RAT”) (e.g., a 5G RAT) when requesting or obtaining precision time services. On the other hand, wireless camera 307 may include an option to communicate wirelessly using other RATs, such as in scenarios where wireless camera 307 is not requesting a precision time service, or may use multiple RATs simultaneously (e.g., may receive a precision time service via a first RAT, and may send or receive other communications via a second RAT). For example, one RAT may exhibit relatively low latency and jitter (and may therefore be used for the precision time service), while another RAT may exhibit higher throughput or lower congestion (and may therefore be used for other services such as sending or receiving a video stream).

Since time synchronization client 105 (and, thus A/V control system 309 and wired cameras 305) and wireless camera 307 receive the same precision time from time synchronization network 301, wired cameras 305 and wireless camera 307 may be able to operate in the same time space (e.g., may be able to be coordinated to operate together on the basis of time that is precise to the order of nanoseconds). For example, a particular wired camera 305 and wireless camera 307 may both be configured to focus on a particular object at the exact same moment in time (e.g., with a margin of error on the order of nanoseconds), thus providing for a precise level of control for an owner or operator of wired cameras 305 and wireless camera 307 (e.g., a film director, editor, camera operator, etc.).

As further shown, the same precision time may be delivered to one or more other devices or systems, such as to MEC 311. As discussed below, MEC 311 may be co-located with and/or may otherwise be associated with one or more base stations of a RAN of a wireless network, such that different MECs 311 may be associated with different services areas of the RAN (e.g., where each service area is associated with a given base station). In other words, at “edges” of the RAN, one or more instances of time synchronization client 105 may be deployed. MECs 311 may be used for low-latency services, such as drone management services, gaming services, video editing services, augmented reality services, etc., as application traffic may be processed by MECs 311 in lieu of traversing a backhaul link between a RAN and a core network.

In this example, assume that a particular time synchronization client 105 is installed at, instantiated at, etc. MEC 311, which may be associated with a base station that is proximate to facility 303 (e.g., facility 303 may be located within a service area of the base station and/or otherwise of MEC 311). Time synchronization client 105 may, as discussed above, receive precision time information from time synchronization network 301 (e.g., from a particular assigned time synchronization node 101), and may implement one or more time-based services. For example, time synchronization client 105 may maintain a sensor monitoring schedule, an alert schedule, etc., and may provide time-based services to wireless IoT device 313 located at facility 303. For example, facility 303 may include configurable lights, speakers, sensors, alarms, fog machines, etc. that may be activated at certain times.

As another example, time synchronization client 105, installed at MEC 311, may maintain or may be communicatively coupled to an application or system that maintains state information associated with an online game (e.g., a massive multiplayer online role-playing game (“MMORPG”), and may process in-game events based on precision time received by time synchronization client 105. Similarly, other instances of time synchronization client 105, installed at other locations (e.g., other MECs 311) may also receive precision time information from time synchronization network 301 (e.g., from respective assigned time synchronization nodes 101), and may process in-game events based on the same precision time. In this sense, multiple different instances of the same application or service (e.g., multiple instances of a gaming service installed at multiple different MECs 311) may be able to perform operations (e.g., process in-game events) on the basis of the exact same precise time as other instances of time synchronization client 105, thus delivering a consistent gaming experience to gamers across a wide area.

Although example use cases of delivering precision time over diverse networks (e.g., wired and wireless) as well as over relatively large areas (e.g., across cites, states, countries, etc.) are discussed above, embodiments described herein extend to a variety of applications and industries. For example, in terms of a warehouse or industrial application, precision time may be used to tightly coordinate the movements of automated robots in factories or warehouses, thus increasing the efficiency and safety of such environments. For example, the amount of “buffer” or “safe” time in between movements of different automated robots or devices may be reduced, since such devices may be controlled precisely (e.g., with a margin of error on the order of nanoseconds) in the time domain.

As another example, different electrical or power facilities may operate on the same precision time based on techniques described herein. Such facilities may be able to perform operations with relatively tight time tolerances, such as activating or deactivating circuit breakers, in a coordinated manner (e.g., at a specific scheduled time, which may be precise down to the nanosecond), thus avoiding risk of overload or other type of failure that could otherwise be caused by similar operations being performed with slight variances in time (e.g., a few milliseconds or seconds in between different facilities operating respective circuit breakers).

In a drone, UAV, autonomous vehicle, etc. setting, precision time may be used to tightly coordinate movements to avoid collisions, improve traffic efficiency, or otherwise aid in the operation of such vehicles. For example, a first vehicle may indicate a predicted location at a specific, precise time, and a second vehicle may take measures to avoid being present at such location at that specific, precise time, thus avoiding a collision. Such vehicles may both include wireless circuitry and may each implement a given time synchronization client 105, via which each vehicle is able to maintain the same precision time information.

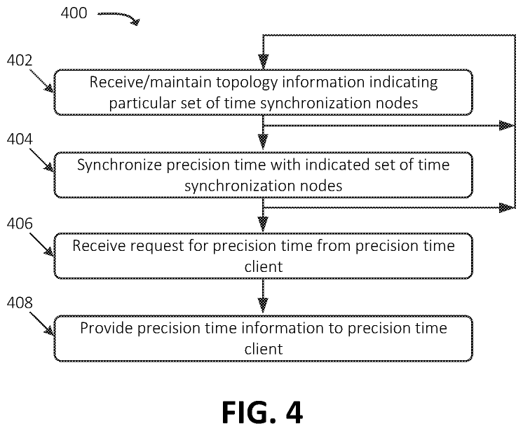

FIG. 4 illustrates an example process 400 for maintaining and delivering precision time information. In some embodiments, some or all of process 400 may be performed by a given time synchronization node 101. For example, a particular time synchronization node 101 may perform some or all of the operations discussed below with respect to process 400. Additionally, multiple instances of time synchronization node 101 may also perform some or all of the operations described below, potentially asynchronously or independently of other time synchronization nodes 101.

As shown, process 400 may include receiving and maintaining (at 402) topology information indicating a particular set of time synchronization nodes 101. For example, as discussed above, time synchronization node 101 may receive (e.g., from TSMS 201 and/or some other suitable source) information indicating a particular set (e.g., subset) of time synchronization nodes 101, out of a group of time synchronization nodes 101 of a particular time synchronization network 301, with which time synchronization node 101 should synchronize time information. As discussed above, the set of time synchronization nodes 101 may be identified based on location, performance of communications metrics between time synchronization nodes 101, quantity of routing hops between time synchronization nodes 101, and/or other suitable factors. Generally, the specific topology and/or routes may be selected such that each time synchronization node 101 is able to deliver precision time information to other time synchronization nodes 101 and/or to time synchronization clients 105. For example, the topology and/or routes may be associated with less than a threshold amount of latency and/or jitter, where such thresholds are associated with the providing of precision time information (e.g., in accordance with a PTP protocol or other suitable protocols for delivering precision time services). As discussed above, the topology information may be refined and/or modified in an ongoing manner, such that optimal performance is ensured and also to remediate any potential failures, such as a particular time synchronization node 101 becoming unreachable or non-operational.

Process 400 may further include synchronizing (at 404) precision time information with the indicated set of time synchronization nodes 101. For example, as discussed above, time synchronization node 101 may communicate with the other time synchronization nodes 101 indicated in the topology information to maintain precision time information (e.g., such that all time synchronization nodes 101 of time synchronization network 301 maintain the same precision time, precise to the order of nanoseconds). As discussed above, time synchronization nodes 101 may communicate bidirectionally and in an ongoing manner, in order to continuously correct any potential errors and maintain the precise time in a synchronized manner.

Process 400 may additionally include receiving (at 406) a request for precision time from a given time synchronization client 105. As discussed above, time synchronization client 105 may have been assigned to the particular time synchronization node 101 based on attributes such as the location of time synchronization node 101 and the location of time synchronization client 105. In some embodiments, time synchronization client 105 may perform a discovery procedure to select time synchronization node 101 from the group of time synchronization nodes 101 of time synchronization network 301, and/or may otherwise communicate with time synchronization node 101 to request precision time information from time synchronization node 101.

Process 400 may also include providing (at 408) precision time information to time synchronization client 105. In some embodiments, time synchronization node 101 may utilize PTP messaging or some other suitable type of messaging to provide the precision time information. As discussed above, time synchronization client 105 may receive the precision time information via one or more wired or wireless networks. In this manner, different time synchronization clients 105 may receive precision time information over diverse types of networks (e.g., wired or wireless), and further may receive the same precision time as other time synchronization clients 105 that are located in different regions. For example, as discussed above, since time synchronization nodes 101 communicate with each other based on a topology specifically selected to maintain the integrity of time information, all time synchronization nodes 101 of time synchronization network 301 may maintain the precision time and may be able to provide the precision time to time synchronization clients 105 located in geographically diverse regions.

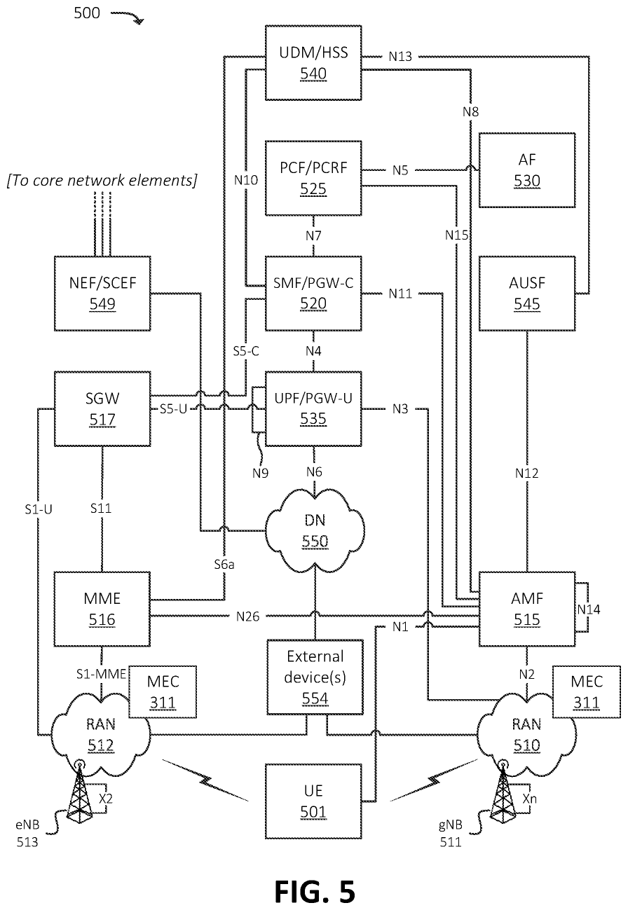

FIG. 5 illustrates an example environment 500, in which one or more embodiments may be implemented. In some embodiments, environment 500 may correspond to a Fifth Generation 5G network, and/or may include elements of a 5G network. In some embodiments, environment 500 may correspond to a 5G Non-Standalone (“NSA”) architecture, in which a 5G RAT may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 500 may represent or may include a 5G core (“5GC”). As shown, environment 500 may include UE 501, RAN 510 (which may include one or more Next Generation Node Bs (“gNBs”) 511), RAN 512 (which may include one or more evolved Node Bs (“eNBs”) 513), and various network functions such as Access and Mobility Management Function (“AMF”) 515, Mobility Management Entity (“MME”) 516, Serving Gateway (“SGW”) 517, Session Management Function (“SMF”)/Packet Data Network (“PDN”) Gateway (“PGW”)-Control plane function (“PGW-C”) 520, Policy Control Function (“PCF”)/Policy Charging and Rules Function (“PCRF”) 525, Application Function (“AF”) 530, User Plane Function (“UPF”)/PGW-User plane function (“PGW-U”) 535, Unified Data Management (“UDM”)/Home Subscriber Server (“HSS”) 540, Authentication Server Function (“AUSF”) 545, and Network Exposure Function (“NEF”)/Service Capability Exposure Function (“SCEF”) 549. Environment 500 may also include one or more networks, such as Data Network (“DN”) 550. Environment 500 may include one or more additional devices or systems communicatively coupled to one or more networks (e.g., DN 550), such as one or more external devices 554.

The example shown in FIG. 5 illustrates one instance of each network component or function (e.g., one instance of SMF/PGW-C 520, PCF/PCRF 525, UPF/PGW-U 535, UDM/HSS 540, and/or AUSF 545). In practice, environment 500 may include multiple instances of such components or functions. For example, in some embodiments, environment 500 may include multiple “slices” of a core network, where each slice includes a discrete and/or logical set of network functions (e.g., one slice may include a first instance of AMF 515, SMF/PGW-C 520, PCF/PCRF 525, and/or UPF/PGW-U 535, while another slice may include a second instance of AMF 515, SMF/PGW-C 520, PCF/PCRF 525, and/or UPF/PGW-U 535). The different slices may provide differentiated levels of service, such as service in accordance with different Quality of Service (“QoS”) parameters.

The quantity of devices and/or networks, illustrated in FIG. 5, is provided for explanatory purposes only. In practice, environment 500 may include additional devices and/or networks, fewer devices and/or networks, different devices and/or networks, or differently arranged devices and/or networks than illustrated in FIG. 5. For example, while not shown, environment 500 may include devices that facilitate or enable communication between various components shown in environment 500, such as routers, modems, gateways, switches, hubs, etc. In some implementations, one or more devices of environment 500 may be physically integrated in, and/or may be physically attached to, one or more other devices of environment 500. Alternatively, or additionally, one or more of the devices of environment 500 may perform one or more network functions described as being performed by another one or more of the devices of environment 500.

Additionally, one or more elements of environment 500 may be implemented in a virtualized and/or containerized manner. For example, one or more of the elements of environment 500 may be implemented by one or more Virtualized Network Functions (“VNFs”), Cloud-Native Network Functions (“CNFs”), etc. In such embodiments, environment 500 may include, may implement, and/or may be communicatively coupled to an orchestration platform that provisions hardware resources, installs containers or applications, performs load balancing, and/or otherwise manages the deployment of such elements of environment 500. In some embodiments, such orchestration and/or management of such elements of environment 500 may be performed by, or in conjunction with, the open-source Kubernetes® application programming interface (“API”) or some other suitable virtualization, containerization, and/or orchestration system.

Elements of environment 500 may interconnect with each other and/or other devices via wired connections, wireless connections, or a combination of wired and wireless connections. Examples of interfaces or communication pathways between the elements of environment 500, as shown in FIG. 5, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 5, such as Service-Based Interfaces (“SBIs”), including an Namf interface, an Nudm interface, an Npcf interface, an Nupf interface, an Nnef interface, an Nsmf interface, and/or one or more other SBIs.

UE 501 may include a computation and communication device, such as a wireless mobile communication device that is capable of communicating with RAN 510, RAN 512, and/or DN 550. UE 501 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a Machine-to-Machine (“M2M”) device, or the like), a Fixed Wireless Access (“FWA”) device, or another type of mobile computation and communication device. UE 501 may send traffic to and/or receive traffic (e.g., user plane traffic) from DN 550 via RAN 510, RAN 512, and/or UPF/PGW-U 535. As discussed above, in some embodiments, UE 501 may be, may implement, may be implemented by, may be communicatively coupled to, and/or may otherwise be associated with a particular time synchronization client 105.

RAN 510 may be, or may include, a 5G RAN that includes one or more base stations (e.g., one or more gNBs 511), via which UE 501 may communicate with one or more other elements of environment 500. UE 501 may communicate with RAN 510 via an air interface (e.g., as provided by gNB 511). For instance, RAN 510 may receive traffic (e.g., user plane traffic such as voice call traffic, data traffic, messaging traffic, etc.) from UE 501 via the air interface, and may communicate the traffic to UPF/PGW-U 535 and/or one or more other devices or networks. Further, RAN 510 may receive signaling traffic, control plane traffic, etc. from UE 501 via the air interface, and may communicate such signaling traffic, control plane traffic, etc. to AMF 515 and/or one or more other devices or networks. Additionally, RAN 510 may receive traffic intended for UE 501 (e.g., from UPF/PGW-U 535, AMF 515, and/or one or more other devices or networks) and may communicate the traffic to UE 501 via the air interface.

RAN 512 may be, or may include, a LTE RAN that includes one or more base stations (e.g., one or more eNBs 513), via which UE 501 may communicate with one or more other elements of environment 500. UE 501 may communicate with RAN 512 via an air interface (e.g., as provided by eNB 513). For instance, RAN 512 may receive traffic (e.g., user plane traffic such as voice call traffic, data traffic, messaging traffic, signaling traffic, etc.) from UE 501 via the air interface, and may communicate the traffic to UPF/PGW-U 535 (e.g., via SGW 517) and/or one or more other devices or networks. Further, RAN 512 may receive signaling traffic, control plane traffic, etc. from UE 501 via the air interface, and may communicate such signaling traffic, control plane traffic, etc. to MME 516 and/or one or more other devices or networks. Additionally, RAN 512 may receive traffic intended for UE 501 (e.g., from UPF/PGW-U 535, MME 516, SGW 517, and/or one or more other devices or networks) and may communicate the traffic to UE 501 via the air interface.

One or more RANs of environment 500 (e.g., RAN 510 and/or RAN 512) may include, may implement, and/or may otherwise be communicatively coupled to one or more edge computing devices, such as one or more Multi-Access/Mobile Edge Computing (“MEC”) devices (referred to sometimes herein simply as a “MECs”) 311. MECs 311 may be co-located with wireless network infrastructure equipment of RANs 510 and/or 512 (e.g., one or more gNBs 511 and/or one or more eNBs 513, respectively). Additionally, or alternatively, MECs 311 may otherwise be associated with geographical regions (e.g., coverage areas) of wireless network infrastructure equipment of RANs 510 and/or 512. In some embodiments, one or more MECs 311 may be implemented by the same set of hardware resources, the same set of devices, etc. that implement wireless network infrastructure equipment of RANs 510 and/or 512. In some embodiments, one or more MECs 311 may be implemented by different hardware resources, a different set of devices, etc. from hardware resources or devices that implement wireless network infrastructure equipment of RANs 510 and/or 512. In some embodiments, MECs 311 may be communicatively coupled to wireless network infrastructure equipment of RANs 510 and/or 512 (e.g., via a high-speed and/or low-latency link such as a physical wired interface, a high-speed and/or low-latency wireless interface, or some other suitable communication pathway).

MECs 311 may include hardware resources (e.g., configurable or provisionable hardware resources) that may be configured to provide services and/or otherwise process traffic to and/or from UE 501, via RAN 510 and/or 512. For example, RAN 510 and/or 512 may route some traffic from UE 501 (e.g., traffic associated with one or more particular services, applications, application types, etc.) to a respective MEC 311 instead of to core network elements of 500 (e.g., UPF/PGW-U 535). MEC 311 may accordingly provide services to UE 501 by processing such traffic, performing one or more computations based on the received traffic, and providing traffic to UE 501 via RAN 510 and/or 512. MEC 311 may include, and/or may implement, some or all of the functionality described above with respect to UPF/PGW-U 535, AF 530, one or more application servers, and/or one or more other devices, systems, VNFs, CNFs, etc. In this manner, ultra-low latency services may be provided to UE 501, as traffic does not need to traverse links (e.g., backhaul links) between RAN 510 and/or 512 and the core network.

AMF 515 may include one or more devices, systems, VNFs, CNFs, etc., that perform operations to register UE 501 with the 5G network, to establish bearer channels associated with a session with UE 501, to hand off UE 501 from the 5G network to another network, to hand off UE 501 from the other network to the 5G network, manage mobility of UE 501 between RANs 510 and/or gNBs 511, and/or to perform other operations. In some embodiments, the 5G network may include multiple AMFs 515, which communicate with each other via the N14 interface (denoted in FIG. 5 by the line marked “N14” originating and terminating at AMF 515).

MME 516 may include one or more devices, systems, VNFs, CNFs, etc., that perform operations to register UE 501 with the EPC, to establish bearer channels associated with a session with UE 501, to hand off UE 501 from the EPC to another network, to hand off UE 501 from another network to the EPC, manage mobility of UE 501 between RANs 512 and/or eNBs 513, and/or to perform other operations.

SGW 517 may include one or more devices, systems, VNFs, CNFs, etc., that aggregate traffic received from one or more eNBs 513 and send the aggregated traffic to an external network or device via UPF/PGW-U 535. Additionally, SGW 517 may aggregate traffic received from one or more UPF/PGW-Us 535 and may send the aggregated traffic to one or more eNBs 513. SGW 517 may operate as an anchor for the user plane during inter-eNB handovers and as an anchor for mobility between different telecommunication networks or RANs (e.g., RANs 510 and 512).

SMF/PGW-C 520 may include one or more devices, systems, VNFs, CNFs, etc., that gather, process, store, and/or provide information in a manner described herein. SMF/PGW-C 520 may, for example, facilitate the establishment of communication sessions on behalf of UE 501. In some embodiments, the establishment of communications sessions may be performed in accordance with one or more policies provided by PCF/PCRF 525.

PCF/PCRF 525 may include one or more devices, systems, VNFs, CNFs, etc., that aggregate information to and from the 5G network and/or other sources. PCF/PCRF 525 may receive information regarding policies and/or subscriptions from one or more sources, such as subscriber databases and/or from one or more users (such as, for example, an administrator associated with PCF/PCRF 525).

AF 530 may include one or more devices, systems, VNFs, CNFs, etc., that receive, store, and/or provide information that may be used in determining parameters (e.g., quality of service parameters, charging parameters, or the like) for certain applications.

UPF/PGW-U 535 may include one or more devices, systems, VNFs, CNFs, etc., that receive, store, and/or provide data (e.g., user plane data). For example, UPF/PGW-U 535 may receive user plane data (e.g., voice call traffic, data traffic, etc.), destined for UE 501, from DN 550, and may forward the user plane data toward UE 501 (e.g., via RAN 510, SMF/PGW-C 520, and/or one or more other devices). In some embodiments, multiple instances of UPF/PGW-U 535 may be deployed (e.g., in different geographical locations), and the delivery of content to UE 501 may be coordinated via the N9 interface (e.g., as denoted in FIG. 5 by the line marked “N9” originating and terminating at UPF/PGW-U 535). Similarly, UPF/PGW-U 535 may receive traffic from UE 501 (e.g., via RAN 510, RAN 512, SMF/PGW-C 520, and/or one or more other devices), and may forward the traffic toward DN 550. In some embodiments, UPF/PGW-U 535 may communicate (e.g., via the N4 interface) with SMF/PGW-C 520, regarding user plane data processed by UPF/PGW-U 535.

UDM/HSS 540 and AUSF 545 may include one or more devices, systems, VNFs, CNFs, etc., that manage, update, and/or store, in one or more memory devices associated with AUSF 545 and/or UDM/HSS 540, profile information associated with a subscriber. In some embodiments, UDM/HSS 540 may include, may implement, may be communicatively coupled to, and/or may otherwise be associated with some other type of repository or database, such as a Unified Data Repository (“UDR”). AUSF 545 and/or UDM/HSS 540 may perform authentication, authorization, and/or accounting operations associated with one or more UEs 501 and/or one or more communication sessions associated with one or more UEs 501. DN 550 may include one or more wired and/or wireless networks. For example, DN 550 may include an Internet Protocol (“IP”)-based PDN, a wide area network (“WAN”) such as the Internet, a private enterprise network, and/or one or more other networks. UE 501 may communicate, through DN 550, with data servers, other UEs 501, and/or to other servers or applications that are coupled to DN 550. DN 550 may be connected to one or more other networks, such as a public switched telephone network (“PSTN”), a public land mobile network (“PLMN”), and/or another network. DN 550 may be connected to one or more devices, such as content providers, applications, web servers, and/or other devices, with which UE 501 may communicate.

External devices 554 may include one or more devices or systems that communicate with UE 501 via 550 and one or more elements of 500 (e.g., via UPF/PGW-U 535). In some embodiments, respective external devices 554 may include, may implement, and/or may otherwise be associated with respective time synchronization nodes 101, time synchronization clients 105, reference clock 103, and/or TSMS 201. External devices 554 may include, for example, one or more application servers, content provider systems, web servers, or the like. External devices 554 may, for example, implement “server-side” applications that communicate with “client-side” applications executed by UE 501. External devices 554 may provide services to UE 501 such as gaming services, videoconferencing services, messaging services, email services, web services, and/or other types of services.

In some embodiments, external devices 554 may communicate with one or more elements of environment 500 (e.g., core network elements) via NEF/SCEF 549. NEF/SCEF 549 include one or more devices, systems, VNFs, CNFs, etc. that provide access to information, APIs, and/or other operations or mechanisms of one or more core network elements to devices or systems that are external to the core network (e.g., to external device 554 via DN 550). NEF/SCEF 549 may maintain authorization and/or authentication information associated with such external devices or systems, such that NEF/SCEF 549 is able to provide information, that is authorized to be provided, to the external devices or systems. For example, a given external device 554 may request particular information associated with one or more core network elements. NEF/SCEF 549 may authenticate the request and/or otherwise verify that external device 554 is authorized to receive the information, and may request, obtain, or otherwise receive the information from the one or more core network elements. In some embodiments, NEF/SCEF 549 may include, may implement, may be implemented by, may be communicatively coupled to, and/or may otherwise be associated with a Security Edge Protection Proxy (“SEPP”), which may perform some or all of the functions discussed above. External device 554 may, in some situations, subscribe to particular types of requested information provided by the one or more core network elements, and the one or more core network elements may provide (e.g., “push”) the requested information to NEF/SCEF 549 (e.g., in a periodic or otherwise ongoing basis).

In some embodiments, external devices 554 may communicate with one or more elements of RAN 510 and/or 512 via an API or other suitable interface. For example, a given external device 554 may provide instructions, requests, etc. to RAN 510 and/or 512 to provide one or more services via one or more respective MECs 311. In some embodiments, such instructions, requests, etc. may include QoS parameters, Service Level Agreements (“SLAs”), etc. (e.g., maximum latency thresholds, minimum throughput thresholds, etc.) associated with the services.

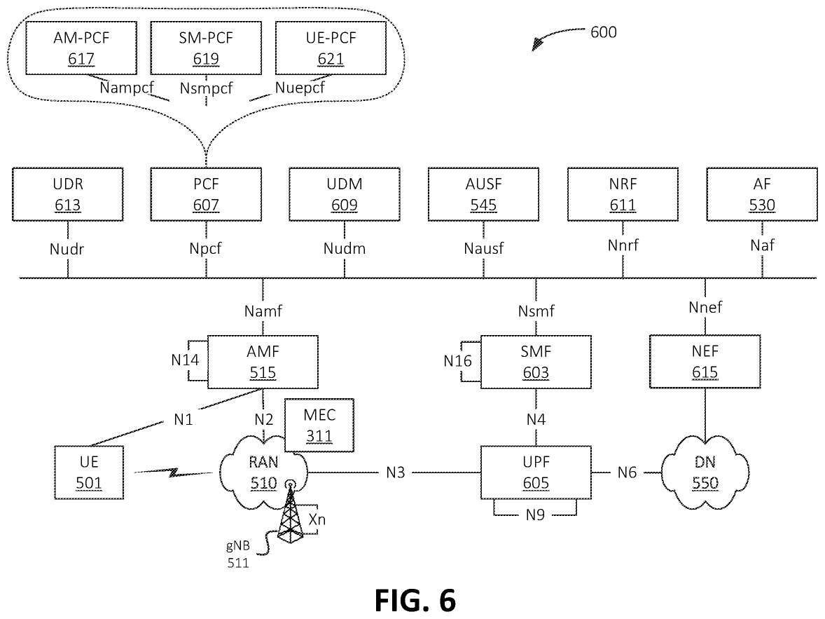

FIG. 6 illustrates another example environment 600, in which one or more embodiments may be implemented. In some embodiments, environment 600 may correspond to a 5G network, and/or may include elements of a 5G network. In some embodiments, environment 600 may correspond to a 5G SA architecture. In some embodiments, environment 600 may include a 5GC, in which 5GC network elements perform one or more operations described herein.

As shown, environment 600 may include UE 501, RAN 510 (which may include one or more gNBs 511 or other types of wireless network infrastructure) and various network functions, which may be implemented as VNFs, CNFs, etc. Such network functions may include AMF 515, SMF 603, UPF 605, PCF 607, UDM 609, AUSF 545, Network Repository Function (“NRF”) 611, AF 530, UDR 613, and NEF 615. Environment 600 may also include or may be communicatively coupled to one or more networks, such as Data Network DN 550.

The example shown in FIG. 6 illustrates one instance of each network component or function (e.g., one instance of SMF 603, UPF 605, PCF 607, UDM 609, AUSF 545, etc.). In practice, environment 600 may include multiple instances of such components or functions. For example, in some embodiments, environment 600 may include multiple “slices” of a core network, where each slice includes a discrete and/or logical set of network functions (e.g., one slice may include a first instance of SMF 603, PCF 607, UPF 605, etc., while another slice may include a second instance of SMF 603, PCF 607, UPF 605, etc.). Additionally, or alternatively, one or more of the network functions of environment 600 may implement multiple network slices. The different slices may provide differentiated levels of service, such as service in accordance with different QoS parameters.

The quantity of devices and/or networks, illustrated in FIG. 6, is provided for explanatory purposes only. In practice, environment 600 may include additional devices and/or networks, fewer devices and/or networks, different devices and/or networks, or differently arranged devices and/or networks than illustrated in FIG. 6. For example, while not shown, environment 600 may include devices that facilitate or enable communication between various components shown in environment 600, such as routers, modems, gateways, switches, hubs, etc. In some implementations, one or more devices of environment 600 may be physically integrated in, and/or may be physically attached to, one or more other devices of environment 600. Alternatively, or additionally, one or more of the devices of environment 600 may perform one or more network functions described as being performed by another one or more of the devices of environment 600.

Elements of environment 600 may interconnect with each other and/or other devices via wired connections, wireless connections, or a combination of wired and wireless connections. Examples of interfaces or communication pathways between the elements of environment 600, as shown in FIG. 6, may include interfaces shown in FIG. 6 and/or one or more interfaces not explicitly shown in FIG. 6. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 600 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 515), an Nudm interface (e.g., indicating communications to be routed to UDM 609), an Npcf interface, an Nupf interface, an Nnef interface, an Nsmf interface, an Nnrf interface, an Nudr interface, an Naf interface, and/or one or more other SBIs.

UPF 605 may include one or more devices, systems, VNFs, CNFs, etc., that receive, route, process, and/or forward traffic (e.g., user plane traffic). As discussed above, UPF 605 may communicate with UE 501 via one or more communication sessions, such as PDU sessions. Such PDU sessions may be associated with a particular network slice or other suitable QoS parameters, as noted above. UPF 605 may receive downlink user plane traffic (e.g., voice call traffic, data traffic, etc. destined for UE 501) from DN 550, and may forward the downlink user plane traffic toward UE 501 (e.g., via RAN 510). In some embodiments, multiple UPFs 605 may be deployed (e.g., in different geographical locations), and the delivery of content to UE 501 may be coordinated via the N9 interface. Similarly, UPF 605 may receive uplink traffic from UE 501 (e.g., via RAN 510), and may forward the traffic toward DN 550. In some embodiments, UPF 605 may implement, may be implemented by, may be communicatively coupled to, and/or may otherwise be associated with UPF/PGW-U 535. In some embodiments, UPF 605 may communicate (e.g., via the N4 interface) with SMF 603, regarding user plane data processed by UPF 605 (e.g., to provide analytics or reporting information, to receive policy and/or authorization information, etc.).

PCF 607 may include one or more devices, systems, VNFs, CNFs, etc., that aggregate, derive, generate, etc. policy information associated with the 5GC and/or UEs 501 that communicate via the 5GC and/or RAN 510. PCF 607 may receive information regarding policies and/or subscriptions from one or more sources, such as subscriber databases (e.g., UDM 609, UDR 613, etc.), and/or from one or more users such as, for example, an administrator associated with PCF 607. In some embodiments, the functionality of PCF 607 may be split into multiple network functions or subsystems, such as access and mobility PCF (“AM-PCF”) 617, session management PCF (“SM-PCF”) 619, UE PCF (“UE-PCF”) 621, and so on. Such different “split” PCFs may be associated with respective SBIs (e.g., AM-PCF 617 may be associated with an Nampcf SBI, SM-PCF 619 may be associated with an Nsmpcf SBI, UE-PCF 621 may be associated with an Nuepcf SBI, and so on) via which other network functions may communicate with the split PCFs. The split PCFs may maintain information regarding policies associated with different devices, systems, and/or network functions.

NRF 611 may include one or more devices, systems, VNFs, CNFs, etc. that maintain routing and/or network topology information associated with the 5GC. For example, NRF 611 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 613 may include one or more devices, systems, VNFs, CNFs, etc. that provide user and/or subscriber information, based on which PCF 607 and/or other elements of environment 600 may determine access policies, QoS policies, charging policies, or the like. In some embodiments, UDR 613 may receive such information from UDM 609 and/or one or more other sources.

NEF 615 include one or more devices, systems, VNFs, CNFs, etc. that provide access to information, APIs, and/or other operations or mechanisms of the 5GC to devices or systems that are external to the 5GC. NEF 615 may maintain authorization and/or authentication information associated with such external devices or systems, such that NEF 615 is able to provide information, that is authorized to be provided, to the external devices or systems. Such information may be received from other network functions of the 5GC (e.g., as authorized by an administrator or other suitable entity associated with the 5GC), such as SMF 603, UPF 605, a charging function (“CHF”) of the 5GC, and/or other suitable network function. NEF 615 may communicate with external devices or systems (e.g., external devices 554) via DN 550 and/or other suitable communication pathways.

While environment 600 is described in the context of a 5GC, as noted above, environment 600 may, in some embodiments, include or implement one or more other types of core networks. For example, in some embodiments, environment 600 may be or may include a converged packet core, in which one or more elements may perform some or all of the functionality of one or more 5GC network functions and/or one or more EPC network functions. For example, in some embodiments, AMF 515 may include, may implement, may be implemented by, and/or may otherwise be associated with MME 516; SMF 603 may include, may implement, may be implemented by, and/or may otherwise be associated with SGW 517; PCF 607 may include, may implement, may be implemented by, and/or may otherwise be associated with a PCRF (e.g., PCF/PCRF 525); NEF 615 may include, may implement, may be implemented by, and/or may otherwise be associated with a SCEF (e.g., NEF/SCEF 549); and so on.

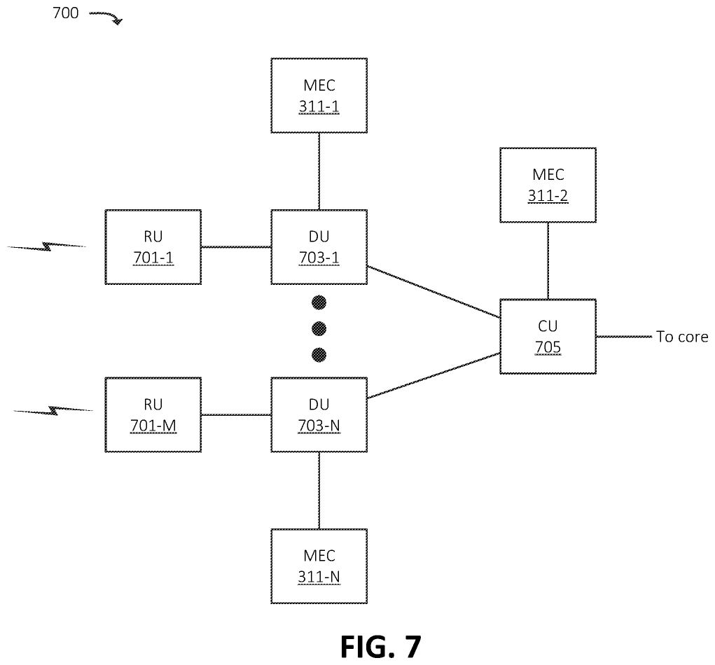

FIG. 7 illustrates an example RAN environment 700, which may be included in and/or implemented by one or more RANs (e.g., RAN 510 or some other RAN). In some embodiments, a particular RAN 510 may include one RAN environment 700. In some embodiments, a particular RAN 510 may include multiple RAN environments 700. In some embodiments, RAN environment 700 may correspond to a particular gNB 511 of RAN 510. In some embodiments, RAN environment 700 may correspond to multiple gNBs 511. In some embodiments, RAN environment 700 may correspond to one or more other types of base stations of one or more other types of RANs. As shown, RAN environment 700 may include Central Unit (“CU”) 705, one or more Distributed Units (“DUs”) 703-1 through 703-N (referred to individually as “DU 703,” or collectively as “DUs 703”), and one or more Radio Units (“RUs”) 701-1 through 701-M (referred to individually as “RU 701,” or collectively as “RUs 701”).

CU 705 may communicate with a core of a wireless network (e.g., may communicate with one or more of the devices or systems described above with respect to FIG. 6, such as AMF 515 and/or UPF 605). In the uplink direction (e.g., for traffic from UEs 501 to a core network), CU 705 may aggregate traffic from DUs 703, and forward the aggregated traffic to the core network. In some embodiments, CU 705 may receive traffic according to a given protocol (e.g., Radio Link Control (“RLC”)) from DUs 703, and may perform higher-layer processing (e.g., may aggregate/process RLC packets and generate Packet Data Convergence Protocol (“PDCP”) packets based on the RLC packets) on the traffic received from DUs 703.

In accordance with some embodiments, CU 705 may receive downlink traffic (e.g., traffic from the core network) for a particular UE 501, and may determine which DU(s) 703 should receive the downlink traffic. DU 703 may include one or more devices that transmit traffic between a core network (e.g., via CU 705) and UE 501 (e.g., via a respective RU 701). DU 703 may, for example, receive traffic from RU 701 at a first layer (e.g., physical (“PHY”) layer traffic, or lower PHY layer traffic), and may process/aggregate the traffic to a second layer (e.g., upper PHY and/or RLC). DU 703 may receive traffic from CU 705 at the second layer, may process the traffic to the first layer, and provide the processed traffic to a respective RU 701 for transmission to UE 501.

RU 701 may include hardware circuitry (e.g., one or more RF transceivers, antennas, radios, and/or other suitable hardware) to communicate wirelessly (e.g., via an RF interface) with one or more UEs 501, one or more other DUs 703 (e.g., via RUs 701 associated with DUs 703), and/or any other suitable type of device. In the uplink direction, RU 701 may receive traffic from UE 501 and/or another DU 703 via the RF interface and may provide the traffic to DU 703. In the downlink direction, RU 701 may receive traffic from DU 703, and may provide the traffic to UE 501 and/or another DU 703.

One or more elements of RAN environment 700 may, in some embodiments, be communicatively coupled to one or more MECs 311. For example, DU 703-1 may be communicatively coupled to MEC 311-1, DU 703-N may be communicatively coupled to MEC 311-N, CU 705 may be communicatively coupled to MEC 311-2, and so on. MECs 311 may include hardware resources (e.g., configurable or provisionable hardware resources) that may be configured to provide services and/or otherwise process traffic to and/or from UE 501, via a respective RU 701.

For example, DU 703-1 may route some traffic, from UE 501, to MEC 311-1 instead of to a core network via CU 705. MEC 311-1 may process the traffic, perform one or more computations based on the received traffic, and may provide traffic to UE 501 via RU 701-1. As discussed above, MEC 311 may include, and/or may implement, some or all of the functionality described above with respect to UPF 605, AF 530, and/or one or more other devices, systems, VNFs, CNFs, etc. In this manner, ultra-low latency services may be provided to UE 501, as traffic does not need to traverse DU 703, CU 705, links between DU 703 and CU 705, and an intervening backhaul network between RAN environment 700 and the core network.

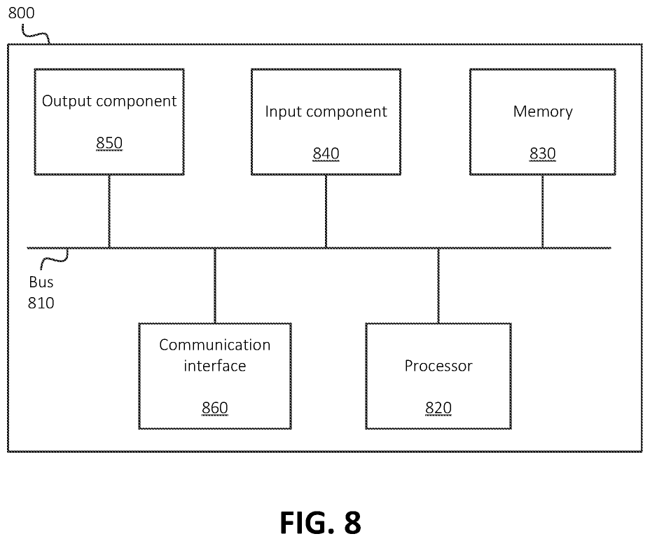

FIG. 8 illustrates example components of device 800. One or more of the devices described above may include one or more devices 800. Device 800 may include bus 810, processor 820, memory 830, input component 840, output component 850, and communication interface 860. In another implementation, device 800 may include additional, fewer, different, or differently arranged components.

Bus 810 may include one or more communication paths that permit communication among the components of device 800. Processor 820 may include a processor, microprocessor, a set of provisioned hardware resources of a cloud computing system, or other suitable type of hardware that interprets and/or executes instructions (e.g., processor-executable instructions). In some embodiments, processor 820 may be or may include one or more hardware processors. Memory 830 may include any type of dynamic storage device that may store information and instructions for execution by processor 820, and/or any type of non-volatile storage device that may store information for use by processor 820.

Input component 840 may include a mechanism that permits an operator to input information to device 800 and/or other receives or detects input from a source external to input component 840, such as a touchpad, a touchscreen, a keyboard, a keypad, a button, a switch, a microphone or other audio input component, etc. In some embodiments, input component 840 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 850 may include a mechanism that outputs information to the operator, such as a display, a speaker, one or more light emitting diodes (“LEDs”), etc.

Communication interface 860 may include any transceiver-like mechanism that enables device 800 to communicate with other devices and/or systems (e.g., via RAN 510, RAN 512, DN 550, etc.). For example, communication interface 860 may include an Ethernet interface, an optical interface, a coaxial interface, or the like. Communication interface 860 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 800 may include more than one communication interface 860. For instance, device 800 may include an optical interface, a wireless interface, an Ethernet interface, and/or one or more other interfaces.

Device 800 may perform certain operations relating to one or more processes described above. Device 800 may perform these operations in response to processor 820 executing instructions, such as software instructions, processor-executable instructions, etc. stored in a computer-readable medium, such as memory 830. A computer-readable medium may be defined as a non-transitory memory device. A memory device may include space within a single physical memory device or spread across multiple physical memory devices. The instructions may be read into memory 830 from another computer-readable medium or from another device. The instructions stored in memory 830 may be processor-executable instructions that cause processor 820 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-4), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
receive topology information indicating a particular set of time synchronization nodes, out of a plurality of time synchronization nodes of a time synchronize network;
communicate with the particular set of time synchronization nodes on an ongoing basis, wherein the device and the plurality of devices maintain precision time information based on the ongoing communication;
receive a request for precision time information from a particular time synchronization client, wherein the particular time synchronization client is assigned to the device based on attributes of the time synchronization client and the device; and
output, to the particular time synchronization client and in response to the request, the requested precision time information.

2. The device of claim 1, wherein the one or more processors are further configured to:
determine the precision time information further based on information received from a reference clock.

3. The device of claim 2, wherein the information received from the reference clock is based on determining Global Positioning System (“GPS”) time information.

4. The device of claim 1, wherein the plurality of time synchronization nodes are distributed in different geographical regions.

5. The device of claim 1, wherein the particular time synchronization client is associated with a particular location, wherein the device is associated with the same particular location, wherein the particular time synchronization client is assigned to the device based on being associated with the same particular location as the device.

6. The device of claim 1, wherein the time synchronization client receives the precision time information via a wireless network, wherein the time synchronization client maintains the same precision time information as the device based on receiving the precision time information via the wireless network.

7. The device of claim 6, wherein the time synchronization client identifies a particular radio access technology (“RAT”) that is associated with particular latency or jitter thresholds associated with a precision time service, wherein the time synchronization client connects to a radio access network (“RAN”) of the wireless network via the identified particular RAT and receives the precision time information via the identified RAT.

8. A non-transitory computer-readable medium storing a plurality of processor-executable instructions, executable by a device, to:
receive topology information indicating a particular set of time synchronization nodes, out of a plurality of time synchronization nodes of a time synchronize network;
communicate with the particular set of time synchronization nodes on an ongoing basis, wherein the device and the plurality of devices maintain precision time information based on the ongoing communication;
receive a request for precision time information from a particular time synchronization client, wherein the particular time synchronization client is assigned to the device based on attributes of the time synchronization client and the device; and
output, to the particular time synchronization client and in response to the request, the requested precision time information.

9. The non-transitory computer-readable medium of claim 8, wherein the plurality of processor-executable instructions further include processor-executable instructions to:
determine the precision time information further based on information received from a reference clock.

10. The non-transitory computer-readable medium of claim 9, wherein the information received from the reference clock is based on determining Global Positioning System (“GPS”) time information.

11. The non-transitory computer-readable medium of claim 8, wherein the plurality of time synchronization nodes are distributed in different geographical regions.

12. The non-transitory computer-readable medium of claim 8, wherein the particular time synchronization client is associated with a particular location, wherein the device is associated with the same particular location, wherein the particular time synchronization client is assigned to the device based on being associated with the same particular location as the device.

13. The non-transitory computer-readable medium of claim 8, wherein the time synchronization client receives the precision time information via a wireless network, wherein the time synchronization client maintains the same precision time information as the device based on receiving the precision time information via the wireless network.

14. The non-transitory computer-readable medium of claim 13, wherein the time synchronization client identifies a particular radio access technology (“RAT”) that is associated with particular latency or jitter thresholds associated with a precision time service, wherein the time synchronization client connects to a radio access network (“RAN”) of the wireless network via the identified particular RAT and receives the precision time information via the identified RAT.

15. A method performed by a device, the method comprising:
receiving topology information indicating a particular set of time synchronization nodes, out of a plurality of time synchronization nodes of a time synchronize network;
communicating with the particular set of time synchronization nodes on an ongoing basis, wherein the device and the plurality of devices maintain precision time information based on the ongoing communication;
receiving a request for precision time information from a particular time synchronization client, wherein the particular time synchronization client is assigned to the device based on attributes of the time synchronization client and the device; and
outputting, to the particular time synchronization client and in response to the request, the requested precision time information.

16. The method of claim 15, further comprising determining the precision time information further based on information determined using Global Positioning System (“GPS”) time information.

17. The method of claim 15, wherein the plurality of time synchronization nodes are distributed in different geographical regions.

18. The method of claim 15, wherein the particular time synchronization client is associated with a particular location, wherein the device is associated with the same particular location, wherein the particular time synchronization client is assigned to the device based on being associated with the same particular location as the device.

19. The method of claim 15, wherein the time synchronization client receives the precision time information via a wireless network, wherein the time synchronization client maintains the same precision time information as the device based on receiving the precision time information via the wireless network.

20. The method of claim 19, wherein the time synchronization client identifies a particular radio access technology (“RAT”) that is associated with particular latency or jitter thresholds associated with a precision time service, wherein the time synchronization client connects to a radio access network (“RAN”) of the wireless network via the identified particular RAT and receives the precision time information via the identified RAT.
